(19) United States
(12) Patent Application Publication
(10) Pub. No.: US 2026/0339830 A1
(43) Pub. Date: Oct. 29, 2026

(54) USER INTERFACE CRAWLER AND AUTOMATED SOFTWARE TESTING SYSTEM

(71) Applicant: Microsoft Technology Licensing, LLC, Redmond, WA (US)

(72) Inventors: Haider SHAH, Brampton (CA); Mikhail JACOB, Vancouver (CA)

(21) Appl. No.: 19/188,579

(22) Filed: Apr. 24, 2025

(51) Int. Cl. G06F 11/3698

(52) U.S. Cl. CPC G06F 11/3698

(57) ABSTRACT

An agent may include a crawler engine configured to create a graph. An agent may include a state detector in communication with the crawler engine and configured to provide state information to the crawler engine. An agent may include an emulator in communication with the crawler engine, wherein the emulator generates emulated inputs in response to an action selected by the crawler engine.

### BACKGROUND

Creation of interactive software applications requires ongoing testing, revisions, and development. The testing can be incremental testing of different combinations of actions or settings, stress testing of the application on a variety of systems, or other tedious or time-consuming tasks. Improvements to the application testing can reduce development time and/or allow for greater refinement of a final product or service.

### BRIEF SUMMARY

In some aspects, the techniques described herein relate to a system for interacting with an interactive software application, the system including: an agent computing device including: a crawler engine configured to create a graph; a state detector in communication with the crawler engine and configured to provide state information to the crawler engine; and an emulator in communication with the crawler engine, wherein the emulator generates emulated inputs in response to an action selected by the crawler engine.

In some aspects, the techniques described herein relate to a method of interacting with an interactive software application, the method including: instantiating an autonomous agent; obtaining at least one of a first video information and first audio information of a user interface (UI) from the interactive software application at a state detector of the autonomous agent; transmitting first state information from the state detector to a crawler engine of the autonomous agent based at least partially on the at least one of first video information and first audio information; selecting an action with the crawler engine in response to the first state information; transmitting the action to an emulator of the autonomous agent; transmitting at least one emulated input of the action to the interactive software application; obtaining at least one of a second video information and second audio information from the interactive software application at a state detector of the autonomous agent; transmitting second state information from the state detector to a crawler engine of the autonomous agent based at least partially on the at least one of second video information and second audio information; and based a difference between the first state information and the second state information, updating a UI graph.

In some aspects, the techniques described herein relate to a method of interacting with an interactive software application, the method including: receiving first state information of a user interface (UI) of an interactive software application at a crawler engine from a state detector; receiving an objective input with the crawler engine from a user; selecting an action with the crawler engine from an action inventory based at least partially on the state information and the objective; transmitting an input to the interactive software application based on the action; after transmitting the input, receiving second state information of the user interface of the interactive software application at the crawler engine from the state detector; comparing a change in state information between the first state information and the second state information to an expected change in state of a graph; and reporting an error, change, or limitation of the UI based on comparing the change to the expected change.

This Summary is provided to introduce a selection of concepts in a simplified form that are further described below in the Detailed Description. This Summary is not intended to identify key features or essential features of the claimed subject matter. Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a diagram illustrating a system including an autonomous agent communicating with an interactive software application, according to at least some embodiments of the present disclosure.

FIG. 2 is a schematic illustration of a machine learning model including a neural network, such as a large language model, according to at least some embodiments of the present disclosure.

FIGS. 3-1 through 3-4 illustrate a sequence of states of a user interface (UI) that is mapped by an autonomous agent, according to at least some embodiments of the present disclosure.

FIG. 4 is a schematic representation of a graph created by an autonomous agent, according to at least some embodiments of the present disclosure.

FIG. 5 is a flowchart illustrating a method of mapping a UI of an interactive software application, according to at least some embodiments of the present disclosure.

FIG. 6 is a system diagram of an autonomous agent in communication with an application module, according to at least some embodiments of the present disclosure.

FIG. 7 is a flowchart illustrating a method of testing an interactive software application, according to at least some embodiments of the present disclosure.

FIG. 8 is a system diagram illustrating a plurality of autonomous agents interacting with interactive software applications in communication with one another, according to at least some embodiments of the present disclosure.

### DETAILED DESCRIPTION

The present disclosure relates generally to systems and methods for the creation and operation of autonomous agents to interact with an interactive software application. More particularly, the present disclosure relates to the training, refinement, and communication of autonomous agents for interacting and testing a user interface (UI) of an interactive software application. Interactive software application development requires extensive development cycles, where a common and time-consuming bottleneck to delivery is testing. In some embodiments, systems and methods according to the present disclosure, allow a developer to build autonomous agents that can test the UI and various menus of the interactive software applications in a workflow similar to a human to accurately replicate a user experience. In some embodiments, autonomous agents accurately simulate human testing and can reduce the time to market for interactive software application development. As the UI and various menus have a limited structure and limited states, the autonomous agent can reliably map and test the UI freeing time for human testers to test other, more open-ended aspects of the interactive software.

Conventional autonomous agent models using reinforcement learning and/or imitation learning models require large computational resources and/or large training datasets. The large computational resources needed for reinforcement learning models are expensive in time, electrical power, and money. For the testing of new interactive software applications, large training datasets are not available. In some embodiments, the UI systems change rapidly such that sometimes it is not feasible to train such models.

In some embodiments, an autonomous agent, according to the present disclosure, includes a crawler engine that interacts with the interactive software application via an emulated user input device. In some embodiments, the autonomous agent includes or has access to an inventory library that allows the agent to change, replace, select, or modify an active crawler engine based at least partially on a user input and/or state information of the interactive software application. For example, different modes, settings, or operating conditions of the interactive software application may produce or allow different possible state information and different possible decisions. By changing, replacing, selecting, or modifying the active crawler engine based at least partially on a user input and/or state information of the interactive software application, the crawler engine can remain lightweight and tailored to the tasks, environment, and decisions currently present in the interactive software application.

In some embodiments, the autonomous agent determines state information about a state of the interactive software application through an object or event detection model. In some embodiments, the object or event detection model includes a machine vision model that detects objects and/or events in the interactive software application through a visual (and, optionally, audio) output of the interactive software application.

In some embodiments, the object or event detection model receives state data from the interactive software application independently of audiovisual information, such as via an application programming interface (API) of the interactive software application. The state data is used to determine the state of the interactive software application and provide the state to a crawler engine of the autonomous agent. In some embodiments, the agent accesses or obtains an application module that identifies and interprets the state data. For example, the application module may interpret the state data as inputs to the crawler engine. In at least one example, the application module allows the crawler engine to interpret an object identification (ID) provided in the state data as an expandable menu within the UI, with which the agent may subsequently attempt to interact based at least partially on an action inventory.

In some examples, input to the autonomous agent (or component of the autonomous agent) and/or output from the autonomous agent (or component of the autonomous agent) is multimodal, which, as used herein, comprises one or more types of content. Example content includes, but is not limited to, spoken or written language (which may also be referred to herein as “natural language output”), code (which may also be referred to herein as “programmatic output”), images, video, audio, gestures, visual features, intonation, contour features, poses, styles, fonts, and/or transitions, among other examples. Thus, as compared to a machine learning model that processes natural language input and generates natural language output, aspects of the present disclosure may process input and generate output having any of a variety of content types.

In some embodiments, the autonomous agent receives one or more objective inputs from a user via a client device that provides the autonomous agent with an objective. In some embodiments, the crawler engine creates or obtains a graph of the UI and interprets the objective inputs to perform one or more tests on the interactive software application based on the graph. In some embodiments, the objective inputs are provided to a crawler engine, and the crawler engine creates a graph of the UI and/or various menus, and interprets the objective inputs to perform one or more tests on the interactive software application based on the graph. In some embodiments, the graph is a map of the UI. In some embodiments, the graph is a branched map. In some embodiments, the map is a digraph. In some embodiments, the graph is a multi-digraph with at least two vertices connected by more than one directed edge. In some embodiments, the graph is a multi-digraph containing a plurality of nodes, wherein each node may include a further multi-digraph.

The crawler engine may then select actions from the action inventory to achieve an objective of the objective input(s). In some embodiments, the objective inputs are provided to a large multimodal model of the crawler engine, and a large multimodal model selects actions from the action inventory to achieve an objective of the objective input(s).

By interpreting state information of the state of the interactive software application, selecting an action from an action inventory of available actions in the interactive software application, and providing inputs to the interactive software application through the emulator, which emulates a physical user input device, some embodiments of an autonomous agent, according to the present disclosure, interact with the interactive software application as a human does. In doing so, an autonomous agent, according to the present disclosure, provides a more accurate simulation of a human testing the interactive software application and a more accurate representation of a human user. In some embodiments, the autonomous agent interacts with and reacts to the interactive software application as a human does, without additional API calls or plugins. For example, from the perspective of the interactive software application, no changes are necessary for the autonomous agent to interpret the audio and/or video information generated by the interactive software application or for the autonomous agent to provide inputs to the interactive software application through an emulated input device.

In at least one embodiment, a system including an autonomous agent, according to the present disclosure, allows a user to provide an objective input(s) to a plurality of autonomous agents interacting with a plurality of copies of the interactive software, thereby allowing the user to conduct or oversee a plurality of concurrent tests of the interactive software application. In some embodiments, a single control plane communicated with a plurality of autonomous agents interacting with a plurality of copies of the interactive software, where the plurality of copies of the interactive software are communicating with one another in a multi-user environment. For example, the plurality of copies of the interactive software may be productivity software in a collaborative operation on a single document or file. In another example, the plurality of copies of the interactive software may be entertainment software, such as a video game, in which multiple users communicated, compete, or cooperate in a shared instance of the game. Testing of the interactive software application is thereby shortened, decreasing the development cycle of the interactive software application.

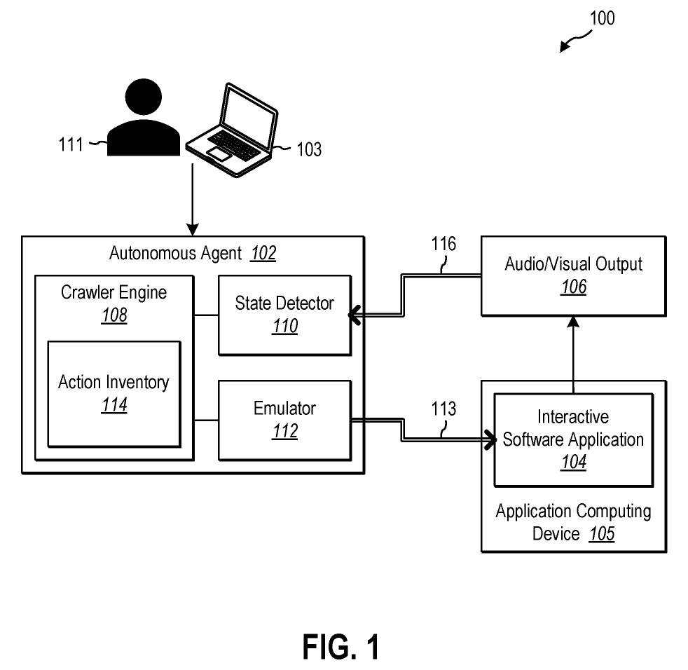

FIG. 1 is a diagram illustrating an embodiment of a system 100 including an autonomous agent 102 communicating with an interactive software application 104. In some embodiments, the interactive software application 104 is executed on an application computing device 105 that runs the interactive software application 104 remotely from the autonomous agent 102. In some embodiments, the application computing device 105 is a personal computing device, such as a laptop computer, a desktop computer, a hybrid computing device, a tablet computing device, a smartphone computing device, a video game console computing device, or other computing device. In some embodiments, the application computing device 105 is a server computing device that executes the interactive software application 104 remotely from the autonomous agent 102. In some embodiments, the application computing device 105 is a client device 103. For example, the application computing device 105 is a desktop computer client device 103, the user 111 interacts with the desktop computer client device 103, and the autonomous agent 102 runs remotely to the client device 103 and the application computing device 105. In at least one example, the application computing device 105 is a video game console, the client device 103 is a personal computing device, and the autonomous agent 102 is executed on a server computer (or plurality of server computers) with which the client device 103 and application computing device 105 communicate via network communications.

In some embodiments, the autonomous agent 102 includes a crawler engine 108 that is configured to test and map the user interface (UI) of the interactive software application being tested. For example, the crawler engine includes a machine learning model and/or script for iterating through sections and menus in the UI to find and record each level or branch of the UI structure. The crawler engine 108 is in data communication with a state detector 110 and an emulator 112. The state detector 110 determines a state of the UI of the interactive software application 104, and the emulator 112 provides inputs to the interactive software application 104. In some embodiments, the crawler engine 108 selects or determines an action from an action inventory 114 based at least partially on the state of the UI detected by the state detector 110 and provides the action to the emulator 112. The emulator 112 converts the action into an input to the interactive software application 104, which changes the state of the UI of the interactive software application 104. The state detector 110 may then detect the change in the state of the UI and the process continues. In some embodiments, the autonomous agent 102 executes locally on the same application computing device 105 as the interactive software application 104. In some embodiments, the autonomous agent 102 executes on a client computing device 103 that is in data communication with the application computing device 105. In some embodiments, the autonomous agent 102 executes on a remote server that is in data communication with the application computing device 105 via a network.

In some embodiments, portions or subsystems of the autonomous agent 102 execute on different computing devices. In at least one embodiment, the application computing device 105 executes the autonomous agent 102. For example, the application computing device 105 is a server computing device that runs both the interactive software application 104 and the autonomous agent 102. In another example, the application computing device 105 is a desktop computing device that runs both the interactive software application 104 and the autonomous agent 102. In some embodiments, the application computing device 105 executes at least one component of the autonomous agent 102. For example, the application computing device 105 executes at least one of a crawler engine 108, a state detector 110, and an emulator 112. In a particular example, a crawler engine 108 transmits an action selected from an action inventory 114 to an emulator 112 that runs natively on the application computing device 105. The emulator 112 then provides emulated inputs 113 to the interactive software application 104.

In some embodiments, the state detector 110 is executed locally (e.g., on the same computing device) as the interactive software application 104. For example, a state detector 110 performs object and/or event detection on video information from the interactive software application 104 rendered on the application computing device 105 and provides the object and/or event detection information to the crawler engine 108 being executed remotely (e.g., on a server computing device).

The interactive software application 104 is any category or genre of interactive software with which a user 111 and/or agent 102 interacts in real-time during usage of the interactive software application 104. In some embodiments, the interactive software application 104 is an electronic game. In some embodiments, the interactive software application 104 is design software, such as computer assisted design software. In some embodiments, the interactive software application 104 is office productivity software, such as a word processor. In some embodiments, the interactive software application 104 is an internet or network browser. In some embodiments, the interactive software application 104 is educational software.

In at least one example, the application computing device 105 and the client device 103 are the same device. In some embodiments, the application computing device 105, an agent computing device (i.e., a computing device executing at least a portion of the autonomous agent 102), and the client device 103 are the same device. In some embodiments, the agent computing device and the client device 103 are the same device. In some embodiments, the agent computing device and the application computing device 105 are the same device.

In some embodiments, the agent computing device includes at least one processor and at least one hardware storage device in communication with the processor. The hardware storage device has instructions stored thereon that, when executed by the processor, cause the agent computing device to execute at least some portions of any of the embodiments of methods described herein and/or execute at least some components of any embodiment of an autonomous agent 102 described herein.

As described herein, the autonomous agent 102 replicates a human user of the interactive software application 104 by use of components that replicate one or more of how a human user receives video and/or audio information 116 from the interactive software application 104, how a human user interprets state information in the video and/or audio information 116, how a human user reacts to the objects and/or events in the UI (e.g., based at least partially on crawler engine 108), how a human user selects an action from the action inventory 114 in response to the state information, and how a human user provides a user input device input (e.g., emulated input 113) to the interactive software application 104 to effect the action in the interactive software application 104. By replicating a human user’s interaction with the interactive software application 104, the autonomous agent 102, in some embodiments, allows for more accurate testing of the interactive software application 104 without direct invention from a human user and/or allows for more accurate simulation of a teammate, an opponent, or another user interacting with the UI of the interactive software application 104 in real-time with a human user.

In some embodiments, the components of the autonomous agent 102 use different types of machine learning models or other logic models to efficiently simulate a human user. The state detector 110 is or includes, in some embodiments, a machine vision neural network to identify virtual objects, textures, characters, animations, events, sounds, or other details of the video and/or audio information as will be described in more detail herein. The emulator 112 is or includes, in some embodiments, an imitation learning model, that allows the emulator to associate emulated inputs 113 with actions selected from the action inventory 114 as will be described in more detail herein.

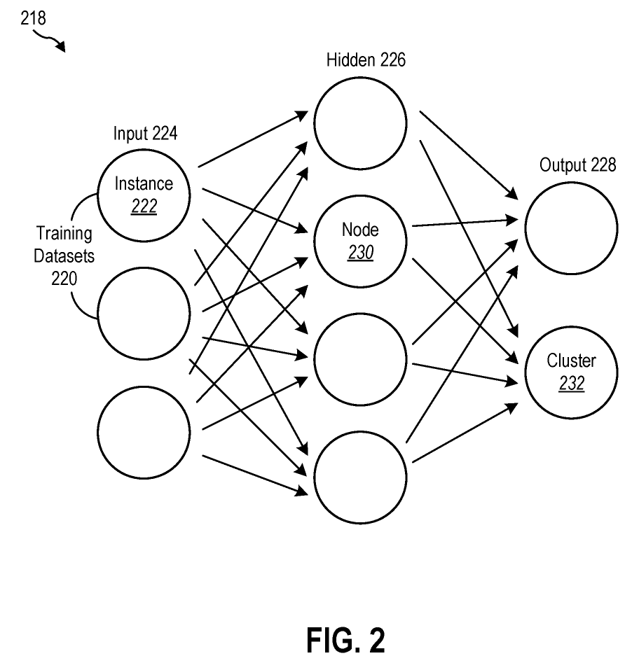

In some embodiments, the autonomous agent includes one or more machine learning models. While a state detector or crawler engine may be explicitly instructed or coded to interact with a particular interactive software application, a machine learning model may allow the autonomous agent to be a generalize agent that interprets and acts on a variety of UIs without explicit prior instruction. FIG. 2 is a schematic illustration of a machine learning model 218 including a neural network, such as a large language model, which may be used in the autonomous agent. In some embodiments, the neural network has a plurality of layers with an input layer 224 configured to receive at least one input training dataset 220 or input training instance 222 and an output layer 228, with a plurality of additional or hidden layers 226 therebetween. The training datasets can be input into the neural network to train the neural network and identify individual and combinations of labels or attributes of the training instances. In some embodiments, the neural network can receive multiple training datasets concurrently and learn from the different training datasets simultaneously. While the illustrated embodiment includes a limited quantity of nodes, it should be understood that, in some embodiments, a large language model has millions, billions, or more of nodes 230 in the input layer 224, hidden layers 226, output layer 228, or combination thereof.

In some embodiments, the machine learning system includes a plurality of machine learning models that operate together. Each of the machine learning models has a plurality of hidden layers 226 between the input layer 224 and the output layer 228. The hidden layers 226 have a plurality of input nodes (e.g., nodes 230), where each of the nodes 230 operates on the received inputs from the previous layer. In a specific example, a first hidden layer 226 has a plurality of nodes and each of the nodes performs an operation on each instance from the input layer 224. Each node of the first hidden layer 226 provides a new input into each node of the second hidden layer, which, in turn, performs a new operation on each of those inputs. The nodes of the second hidden layer then passes outputs, such as identified clusters 232, to the output layer 228.

The machine learning model includes an input layer that receives at least one training dataset. In some embodiments, at least one machine learning model uses supervised training. In some embodiments, at least one machine learning model uses unsupervised training. Unsupervised training can be used to draw inferences and find patterns or associations from the training dataset(s) without known outputs. In some embodiments, unsupervised learning can identify clusters of similar labels or characteristics for a variety of training instances and allow the machine learning system to extrapolate the performance of instances with similar characteristics.

In some embodiments, semi-supervised learning can combine benefits from supervised learning and unsupervised learning. As described herein, the machine learning system can identify associated labels or characteristic between instances, which may allow a training dataset with known outputs and a second training dataset including more general input information to be fused. Unsupervised training can allow the machine learning system to cluster the instances from the second training dataset without known outputs and associate the clusters with known outputs from the first training dataset. The values of the output layer, in some embodiments, are compared to known values of training instances, and parameters associated with each node of the hidden layer(s) allow back propagation through the neural network to refine and train the neural network.

In at least one example, a machine learning model or neural network, according to the present disclosure, is trained on a corpus of training datasets including millions, billions, or more of training instances. The resulting model may be able to recognize and interpret video, audio, or other elements of UIs without prior instruction. The resulting model may be able to recognize and record states of the UI in a branching map of the UI with the logical connections between states.

In at least another example, the resulting model allows a user (such as user 111 of FIG. 1) to provide objective inputs or other inputs to the model to interact with the interactive software application (such as the interactive software application 104 of FIG. 1) for testing of various aspects of the UI. In some embodiments, the large multimodal model, based at least partially on the inputs of the user, creates a crawler engine and/or operates the crawler engine (such as the crawler engine 108 of FIG. 1) of an autonomous agent to test one or more portions of the UI.

FIG. 3-1 through FIG. 3-4 illustrate various states of an embodiment of a UI being mapped and/or tested by an autonomous agent (such as any embodiment of the autonomous agents 102 described in relation to FIG. 1). The autonomous agent includes a state detector to determine a state of the UI of the interactive software application. The state detector may include a visual language model, an audio language model, an optical character recognition (OCR) model, or other models that allow the state detector to identify various aspects of the UI and detect the various states. The crawler engine of the autonomous agent may then associate the various states with changes due to inputs to the interactive software application by the emulator to create the graph of the UI and the inputs that initiate the transitions between the states of the graph.

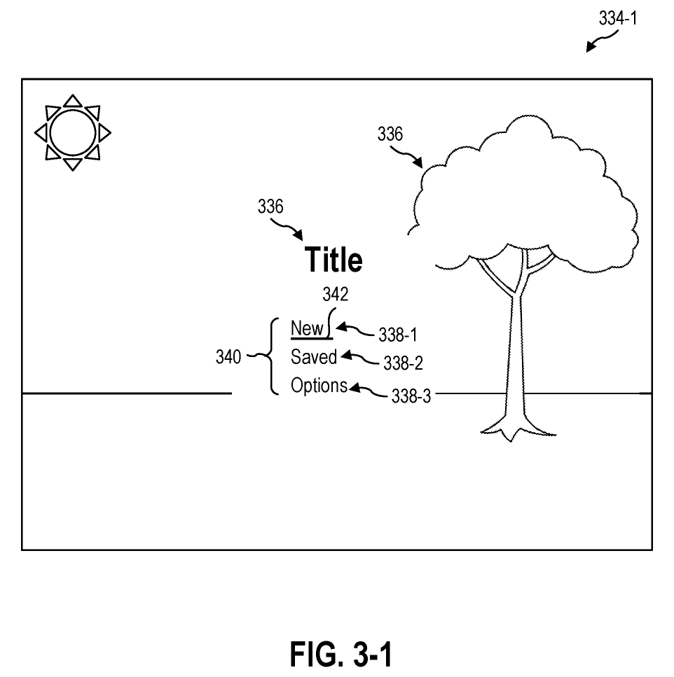

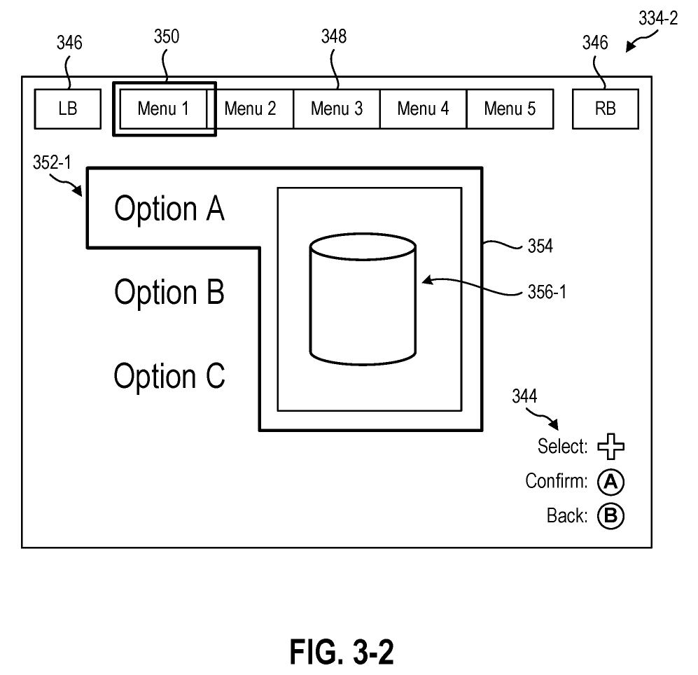

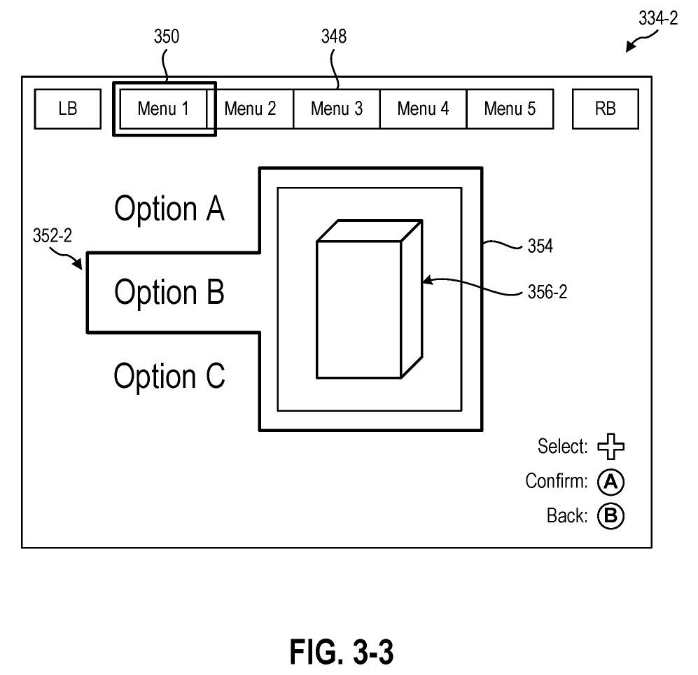

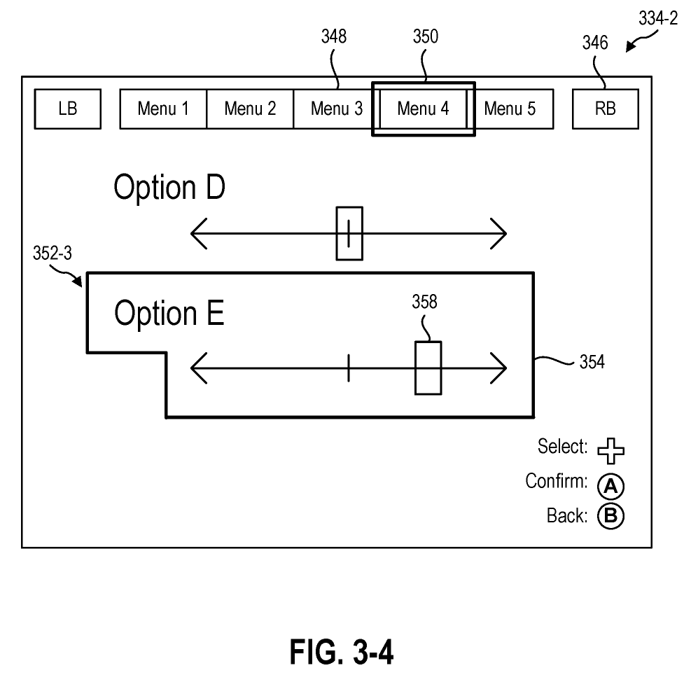

FIG. 3-1 is an embodiment of a top menu UI 334-1 that includes a plurality of visual elements. In some embodiments, the state detector of the autonomous agent evaluates the UI 334-1 to differentiate between non-interactable elements 336, such as the title and aesthetic elements (the tree, the sun, the ground, etc.), and interactable elements 338-1, 338-2, 338-3 that may be selected by inputs to the interactive software application. In the illustrated embodiment of FIG. 3-1, the interactable elements as arranged in a list 340 that may be cycled through using a directional input. In some embodiments, the UI includes a cursor or other visual indicator 342 that identifies a selected element of the UI. The crawler engine may provide actions to the emulator, which in turn provides inputs to the interactive software application, to attempt changes to the UI. In the embodiment illustrated in FIG. 3-1, the crawler engine may provide directional inputs via the emulator, while the state detector identifies the relative movement of the visual indicator 342 between the interactable elements 338-1, 338-2, 338-3 of the list 340.

In some embodiments, the autonomous agent iterates through available actions and/or inputs to the interactive software application to determine the effect on the state(s) of the UI by those respective actions. In some embodiments, the state detector or other visual language model or OCR model may identify an input legend in the UI. For example, FIG. 3-2 is an embodiment of an Options UI 334-2 that is attained by selection of the Options interactable element 338-3 of FIG. 3-1. In some embodiments, the UI 334-2 includes an input legend 344 and/or input cues 346 that allow a user (or the autonomous agent) to associate various inputs with available actions in the UI 334-2. In some embodiments, the input legend 344 is a generalized legend for actions associated with inputs to the UI. For example, the input legend 344 may provide information to the user and/or autonomous agent regarding movement of the visual indicator and/or selection of the indicated interactable elements throughout the UI or current pane of the UI. In some embodiments, an input cue 346 indicates an available input relative to a particular list, menu, or other subsection of the UI. For example, the input cue 346 illustrated in the embodiment of an Options UI 334-2 of FIG. 3-2 indicates inputs that move a menu visual indicator 350 within or across a menu bar 348 located along a top portion of the Options UI 334-2.

In some embodiments, the Menu 1 indicated by the menu visual indicator 350 includes a plurality of interactable elements in a list, such as a first interactable element 352-1 that is indicated by an element visual indicator 354 in FIG. 3-2. In some embodiments, display information changes depending on the selected and/or indicated interactable element. For example, the element visual indicator 354 indicates a first information field 356-1 when the element visual indicator 354 is located at least partially on the first interactable element 352-1.

Referring now to FIG. 3-3, an embodiment of another state of the Options UI 334-2 of FIG. 3-2 is illustrated with a second interactable element 352-2 selected. The menu visual indicator 350 continues to indicate the same Menu 1 within the menu bar 348, and the element visual indicator 354 has moved to the second interactable element 352-2. The information field of the element visual indicator 354 is now a second information field 356-2 presenting different information to the user and/or autonomous agent. In some embodiments, further interactable elements are presented in the information field and/or other subfields of the UI.

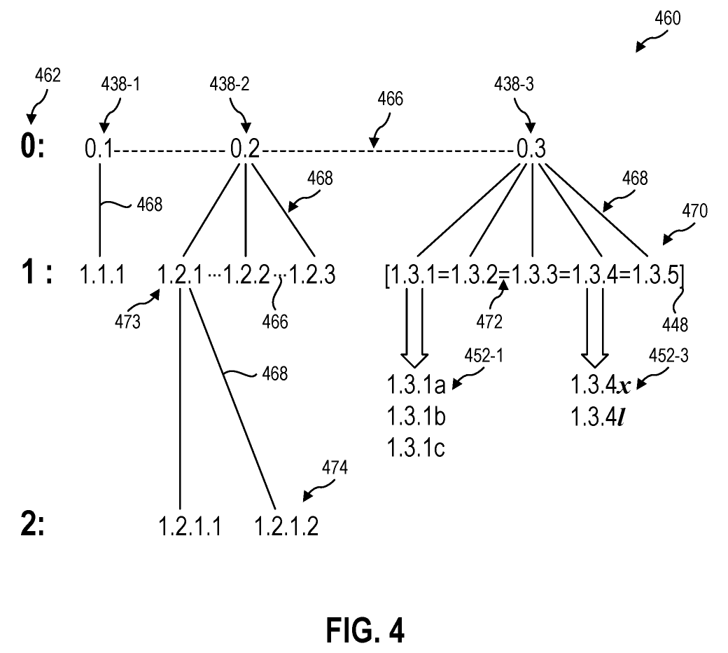

FIG. 3-4 illustrates yet another state of the Options UI 334-2 with, for example, Menu 4 selected in the Menu bar 348. The menu visual indicator 350 now indicates the fourth interactable element in the Menu bar 348, such as by movement of the menu visual indicator 350 based on inputs associated with the input cues 346, and the element visual indicator 354 indicates a third interactable element 352-3 of the UI 334-4. In some embodiments, element visual indicator 354 further selects and enables interaction with an interactable subelement 358 of the UI. In such examples, the slider cursor subelement 358 is movable within the element visual indicator 354.

An autonomous agent including a crawler engine according to the present disclosure may iterate through the states of a UI to determine available actions within the UI and the transitions between states based on the available actions. In some embodiments, the available actions are determined by iteration through each available input in an emulator of the autonomous agent, as will be described in more detail herein. In some embodiments, the available actions are determined by the state detector identifying an input legend or input cues presented in the UI. In some embodiments, the various states of the UI and the transitional inputs to effectuate those states are recorded in a graph of the UI.

In some embodiments, the graph is recorded in the autonomous agent to train the autonomous agent for use on the interactive software application. In some embodiments, the graph is recorded in an application module associated with the interactive software application, where the application module is accessible by the autonomous agent or by other autonomous agents when interacting with the interactive software application. For example, the application module may be stored on a remote server with which an autonomous agent may communicate. In some embodiments, the application module may further include information related to the interactive software application to facilitate testing of the interactive software application by the autonomous agent after creation of the graph, such as an action inventory created during the mapping of the UI. The application module may, therefore, save time and/or resources for testing of future builds of the interactive software application or by testing of the interactive software application by other instances of an autonomous agent on other computing devices and/or in other locations.

FIG. 4 illustrates an embodiment of a graph 460 created by an autonomous agent described herein. In some embodiments, the graph 460 of the UI of the interactive software application includes a plurality of interactable elements arranged by navigable paths in the UI. In some embodiments, the graph 460 includes a plurality of tiers 462 that present a topology of the UI. In the illustrated embodiment of a graph 460 of FIG. 4, three tiers 462 are included, wherein the first tier 464 schematically represents the top menu UI 334-1 described in relation to FIG. 3-1. The first tier 464 includes a plurality of interactable elements 438-1, 438-2, 438-3 that are navigable by a navigable path therebetween. The first tier 362 is recorded in the graph 460 as navigable by sequential inputs between the first interactable element 438-1 and the second interactable element 438-2 and between the second interactable element 438-2 and the third interactable element 438-3.

In some embodiments, the graph 460 includes a plurality of types of navigable paths. For example, the navigable path between the first interactable element 438-1 and the second interactable element 438-2 is denoted as a directional input path 446, which associated an action and/or input with navigating between those elements. In another example, a confirmation input path 468 associates a transition between the third interactable element 438-3 of the first tier 464 and a second tier 470 by a confirmation action and/or by an “A” button input associated with the “confirm” action (e.g., as determined from the action legend 344 described in relation to FIG. 3-2).

The second tier 470 of the third interactable element 438-3 includes a menu bar 448 that is navigable by shoulder button input paths 472 that correspond to the inputs indicated by the input cues in the UI (such as the input cues 346 described in relation to FIG. 3-2). In some embodiments, a tier includes subtiers that present different interactable elements and/or lists based on the indicated or selected elements within the tier. For example, selection of different menu elements in the menu bar 448 may present different lists of interactable elements, such as a first interactable element 452-1 of the second tier 470 (corresponding to the first interactive element 352-1 and information field 356-1 described in relation to FIG. 3-2) and a third interactable element 452-3 in a different list of the second tier 470 (corresponding to the third interactive element 352-3 and interactable subelement 358 described in relation to FIG. 3-3).

As illustrated in the graph 460 of FIG. 4, the graph 460 includes a list 473 of the second tier 470 of the second interactable element 438-2 of the first tier 464. The list 473 includes a plurality of interactable elements that are navigable by a directional input path 466 therebetween. In some embodiments, the interactable elements are further confirmable by a confirmation action to navigate a confirmation input path 468 to a third tier 474 of the graph 460. In some embodiments, the confirmation input paths are navigable in an opposite direction by another action and/or input, such as the “Back” action (e.g., as determined from the action legend 344 described in relation to FIG. 3-2).

To create the graph, the autonomous agent iterates through all states of the UI by attempting each available action and/or input during each state to fully explore the UI. In some embodiments, the autonomous agent includes scripted actions that transition between UI sections. In some embodiments, the scripted actions may be received from another machine learning model or agent. For example, FIG. 4 illustrates a graph of a UI in which all portions of the UI are connected in by navigable paths in the graph. In some embodiments, an interactive software application has a plurality of sections of the UI that are not connected by navigable paths within each UI. For example, the top menu UI 334-1 and the Options UI 334-2 described in relation to FIG. 3-1 through FIG. 3-4 are navigable therebetween. In some embodiments, the same interactive software application may include a Pause Menu UI or Round End UI, or another section of the UI that is not navigable. In such embodiments, the autonomous agent may include or access scripted actions that transition the interactive software application to the next section of the UI. For example, the first interactable element 338-1 may initiate a new instance of the game instantiated by the interactive software application. A scripted action may launch the new game, wait pre-determined period of time, and pause the game to access the Pause UI.

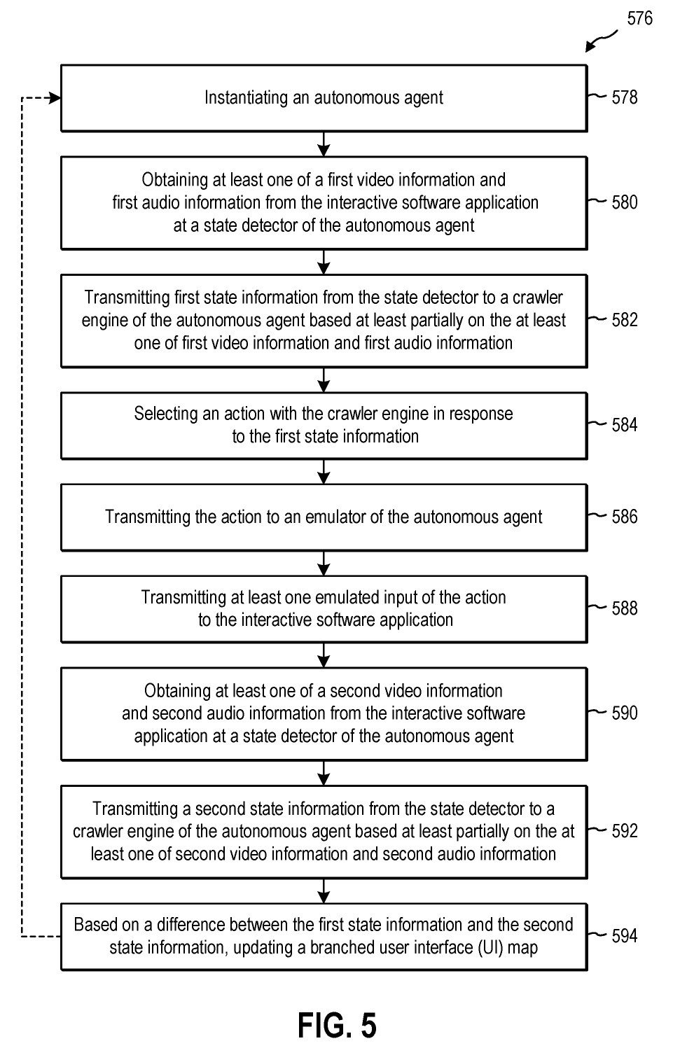

In some embodiments, the UI In some embodiments, the graph is only created once per version or build of the interactive software application, and the graph is then stored in the autonomous agent and/or in an application module accessible by the autonomous agent. FIG. 5 is a flowchart illustrating an embodiment of a method 576 of creating a graph using an autonomous agent according to the present disclosure.

In some embodiments, the method 576 includes instantiating an autonomous agent at 578. In some embodiments, the autonomous agent is instantiated on the same computing device that executes the interactive software application. In some embodiments, the autonomous agent is instantiated on a different computing device that executes the interactive software application. In some embodiments, the autonomous agent is distributed across a plurality of computing devices when instantiated, such as a crawler engine instantiated on an agent computing device and an emulator of the autonomous agent instantiated on the application computing device that executes the interactive software application. In some embodiments, individual features and/or elements of a respective module or component of the autonomous agent may be distributed across multiple device. For example, a state detector may include a vision model executed remotely in a cloud-based server while an OCR model is executed locally on the agent computing device and/or application computing device.

The method 576 further includes obtaining at least one of first video information and first audio information from the interactive software application at a state detector of the autonomous agent at 580. In some embodiments, the state detector detects at least one of visual cues, audio cues, objects, textures, characters, animations, events, and combinations thereof (state information) from the at least one of video information, audio information, and software state data from the interactive software application, and the method 576 including transmitting first state information from the state detector to a crawler engine of the autonomous agent based at least partially on the at least one of first video information and first audio information at 582.

In some embodiments, the method 576 includes selecting an action with the crawler engine in response to the first state information at 584. In some embodiments, the action is selected based on a plurality of available actions identified in an input legend or input cue detected in the state information. In some embodiments, the action is selected based on actions identified based on available inputs of the emulated input device of the emulator. In some embodiments, the action is selected from an action inventory of the crawler engine. In some embodiments, the action inventory is created by a user training an imitation learning model (such as a neural network with supervised or semi-supervised training) of user inputs into a user input device.

The method 576 further includes transmitting the action to an emulator of the autonomous agent at 586 and transmitting at least one emulated input of the action to the interactive software application at 588. The emulator, in some embodiments, emulates the transmissions of a user input device to provide emulated inputs to the interactive software application. In some embodiments, the emulator receives a selected action (such as from the action inventory 114 of FIG. 1) from the crawler engine and emulates the user inputs associated with the action to create one or more emulated inputs (such as emulated inputs 113 of FIG. 1) to the interactive software application. In such embodiments, different emulators allow the autonomous agent to interact with different platforms running the interactive software application(s). For example, an interactive software application built for a personal computer may receive inputs from an emulator of a keyboard and mouse user input device. In another example, an interactive software application built for a video game console may receive inputs from an emulator of a gamepad user input device.

In some embodiments, for a crawler engine to select an action, the action inventory is created by training the emulator using a physical user input device that corresponds to the device emulated. In some embodiments, an emulator described herein is part of the system and/or agent described in relation to FIG. 1. The emulator receives user inputs from the user input device and associates the user inputs to the user input device as the user inputs to effectuate the associated action. For example, “navigate” is an action that is associated with a user input to the left thumbstick. The imitation model of the emulator then produces an emulated input of a measured direction and magnitude of a left thumbstick to the interactive software application when the “navigate” action is selected by the crawler engine. In other embodiments, the action includes a plurality of user inputs, either sequential or simultaneous, that are emulated by the emulator to cause the action in the interactive software application.

For example, additional menus may be accessed by input of a “code” of directional and/or button inputs, such as directional inputs up, up, down, down, left, and right, and a “B” button, and “A” button in sequence. In some embodiments, the crawler engine selects “code” as a selected action from a plurality of available actions. The emulator, in such an embodiment, receives the selected action and emulates the series of and/or simultaneous emulated inputs to the interactive software application.

In some embodiments, the user input device is a keyboard, computer mouse, video camera, depth camera, microphone, gamepad, touch-sensitive device, motion-sensing device, steering wheel, yoke, pedal, joystick, or other hardware peripheral capable of providing user inputs to the interactive software application. In some embodiments, a type, category, or specific user input device is defined by the interactive software application. For example, some interactive software applications include a list of compatible user input devices, such as a keyboard-and-mouse and a gamepad.

In some embodiments, the emulator is trained via supervised training from training datasets of user inputs with a first user input device while the emulator generates emulated inputs that emulate a second user input device. In at least one example, an action inventory includes “turn left”, and the emulator has an associated emulated input of turn left that includes a 50% left input of a steering wheel user input device. In some embodiments, the interactive software application running on the application computing device is compatible with gamepads and keyboards, and the emulator provides to the interactive software application a 50% left input of an emulated left thumbstick.

In some embodiments, the method 576 further includes obtaining at least one of second video information and second audio information from the interactive software application at a state detector of the autonomous agent at 590. For example, obtaining the second video information and/or second audio information may be similar to obtaining at least one of first video information and first audio information from the interactive software application.

In some embodiments, the method 576 includes transmitting the second state information from the state detector to a crawler engine of the autonomous agent based at least partially on the at least one of second video information and second audio information at 592. The method 576 further includes, based a difference between the first state information and the second state information, updating a graph of the UI at 594. In some embodiments, the graph is recorded on the agent computing device. In some embodiments, the graph is recorded on a server computing device, such as on a cloud-based computing device.

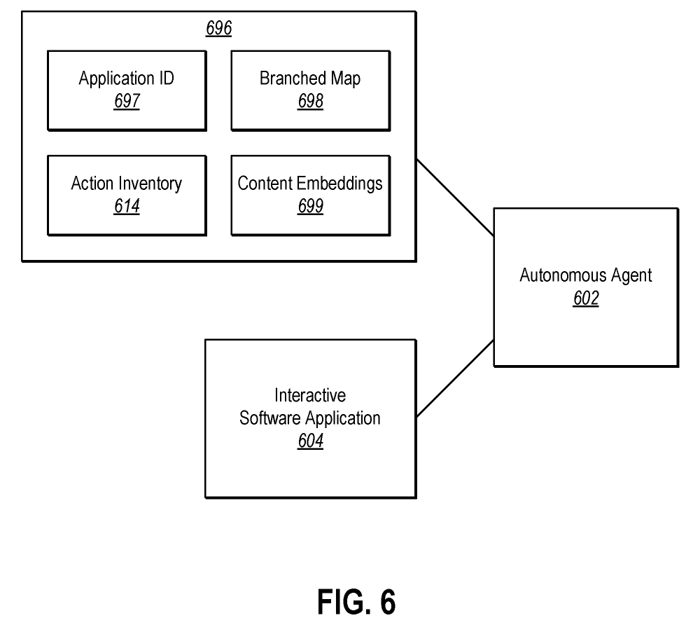

In some embodiments, the graph is recorded in an application module. FIG. 6 is a system diagram of an application module 696 in data communication with an autonomous agent 602, such as described in relation to FIG. 1. In some embodiments, the application module 696 is accessible by the autonomous agent 602 to provide the autonomous agent 602 with information relevant to the interactive software application 604.

In some embodiments, the application module 696 includes an action inventory 614. For example, the application module 696 may include a plurality of available actions related to the interactive software application via an interactive software application ID 697. In some embodiments, the autonomous agent 602 receives an interactive software application ID 697 from the interactive software application 604. In some embodiments, the autonomous agent 602 identifies one or more identifying features of the interactive software application 604 to determine the interactive software application ID 697. In some embodiments, the autonomous agent 602 creates and records the interactive software application ID 697 in the application module 696 for future detection of the interactive software application 604 and/or application module 696 during testing.

In some embodiments, the application module 696 includes a stored graph 698. For example, the autonomous agent 602 may create and record the graph 698 in the application module 696 for future access. In some embodiments, the autonomous agent 602 updates the graph 698 upon detection of a UI state not identified in the graph 698. In some embodiments, the graph 698 is associated with a build or version of the interactive software application 604. For example, the autonomous agent 602 may create a first graph 698 associated with a first version of the build or version of the interactive software application 604 and record the first graph 698 in the application module 696. The autonomous agent 602 may create a second graph associated with a second build or version of the interactive software application 604 and compare the first graph 698 against the second graph to determine changes between builds or versions of the interactive software application 604. In some embodiments, the autonomous agent 602 accesses the stored graph 698 in the application module 696 to determine changes to the UI between builds or versions of the interactive software application 604.

In some embodiments, updating the UI graph includes adding, updating, or modifying one or more nodes in the UI graph. For example, the nodes of the UI graph may include option nodes and/or screen nodes. The option nodes reflect one or more options within a menu or a screen. For example, option nodes reflects the various lists, settings, or menus available within a single screen of the UI. A screen node may reflect a single screen within the UI graph. In some embodiment, a screen node includes one or more option nodes. In some embodiments, the crawler engine executes an inner loop and an outer loop of the engine to graph the UI. In some embodiments, the outer loop of the crawler engine updates the screen node(s) of the UI graph. In some embodiments, the inner loop of the crawler engine updates the option node(s) of the UI graph.

While the autonomous agent 602 described herein includes vision models, audio models, and/or OCR models to generalize the autonomous agent 602 and allow operation with various interactive software applications 604 without prior explicit training or instruction, in some embodiments, accessing the application module 696 allows the autonomous agent 602 to pre-populate with known actions or objects related to the interactive software application. For example, the application module 696 may further include content embeddings 699 that may be accessed by the autonomous agent 602 and, particularly, the state detector of the autonomous agent 602. Pre-loading and/or pre-populating the state detector with known content embeddings 699 may allow faster and/or more reliable detection of UI elements (interactable or non-interactable). In some embodiments, the application module 696 includes a scripted action, such as described in relation to FIG. 4 that allows the autonomous agent to transition between sections of the UI that are not navigable therebetween within the UI.

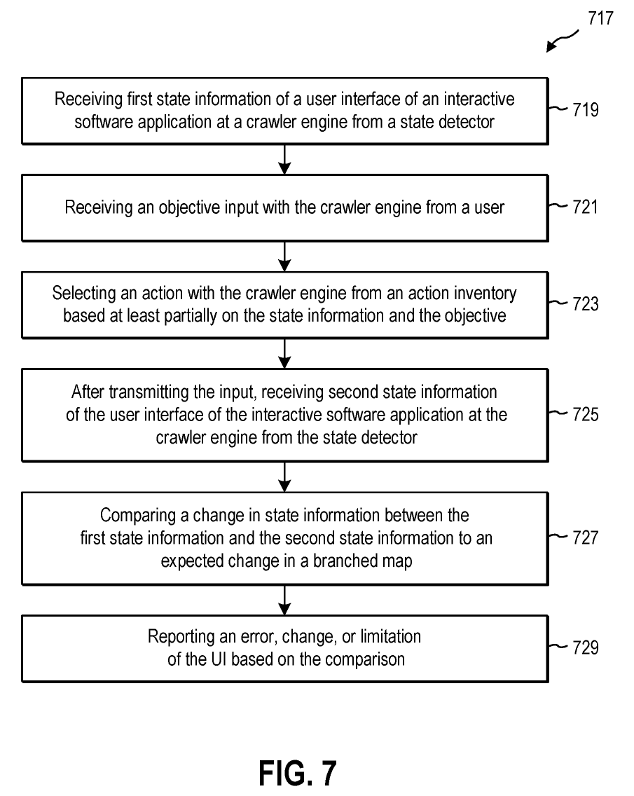

After creation of the graph and/or action inventory, in some embodiments, the autonomous agent may be used for automated objective-based testing of the UI by the autonomous agent. FIG. 7 is a flowchart illustrating a method 717 of testing interactive software applications using an autonomous agent according to some embodiments of the present disclosure.

The crawler engine is or includes, in some embodiments, a state machine (e.g., a heuristic-based state machine). In some embodiments, the crawler engine receives the state information from the state detector at 719. In some embodiments, the crawler engine receives an objective input(s) from a user at 721, (such as the user 111 via the client device 103 of FIG. 1) and trains or creates the crawler engine with an array of available actions and reactions that effectuate an objective.

In at least one embodiment, the crawler engine makes determinations toward effectuating the objective. In some embodiments, the crawler engine selects an action from the action inventory based at least partially on the state information and the objective at 723. For example, the crawler engine may identify a state of the UI based on the state information, such as a state of the UI in the graph, as described in relation to FIG. 4. The crawler engine, based at least partially on the navigable path(s) of the graph and the objective, may selected an action to navigate the UI based on the graph.

For example, the objective input from the user may include an objective or instruction to the autonomous agent to navigate between selected UI states a predetermined number of times. In another example, the objective input from the user may include an objective or instruction to the autonomous agent to navigate to one or more UI states and modify one or more interactable elements (such as sliders, toggles, or other adjustable subelements of the UI). The method 717 further includes receiving second state information from the interactive software application at 725 and comparing the change in state information between the first state information and the second state information to an expected change in a graph at 727.

In some embodiments, the expected change is an expected change based on an objective input provided by a user, such as via a client device, as described in relation to FIG. 1. In some embodiments, the expected change is received by a large multimodal model and interpreted for or by the crawler engine. In some embodiments, the expected change is based on expected content of visual information of the UI screen or UI options. For example, the expected content may be text of a particular language, such as during UI translation or localization. In some examples, the expected content may be particular colors or images in the UI, such as icons, logos, banners, borders, or other visual elements of the UI. In some embodiments, the expected change is a state change based on navigable paths of the UI graph. For example, a “back” action in a screen or page of the UI would provide an expected change of a movement upward and/or backward through the UI graph of the UI. If the autonomous agent provides the input associated with a “back” action, and the UI does not change according to the expected change, an error may be generated.

In some embodiments, upon completion of the objective or instruction, the autonomous agent optionally reports or records errors, changes, or limitations of the UI at 729. For example, the autonomous agent may record changes to the UI graph in a second graph of the application module.

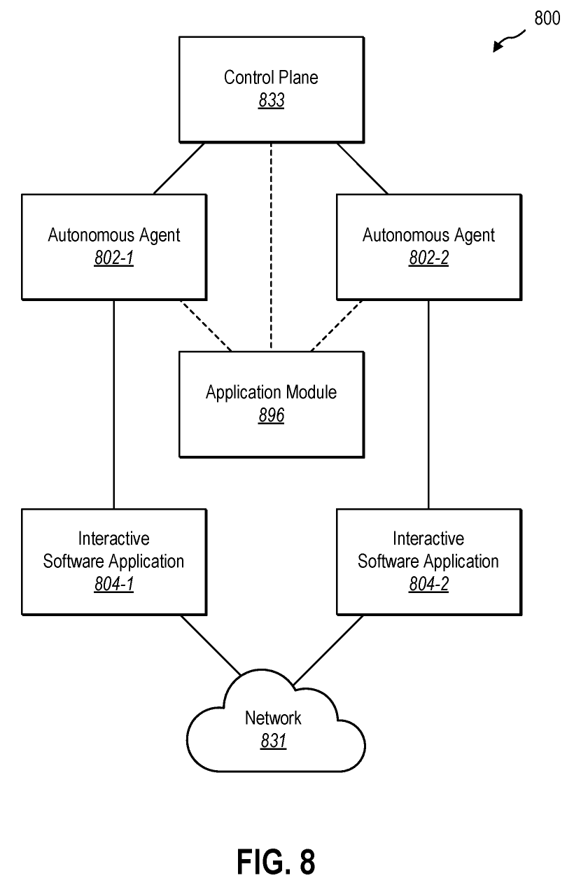

FIG. 8 is a system diagram of a system 800 for testing multi-user UIs in interactive software applications. For example, testing multi-user UIs conventionally requires multiple human testers. While human testers are a valuable resource to allocate to UI testing, coordinating multiple human testers presents additional logistical challenges. An automated agent system can allow a single human user to oversee multiple autonomous agents. In some embodiments, the system 800 includes a plurality of autonomous agents, such as at least a first autonomous agent 802-1 and a second autonomous agent 802-2.

In some embodiments, each of the autonomous agents 802-1, 802-2 is in data communication with a unique instance or copy of the interactive software application being tested. For example, the first autonomous agent 802-1 is in data communication with a first copy of the interactive software application 804-1, and the second autonomous agent 802-2 is in data communication with a second copy of the interactive software application 804-2. In some embodiments, the first interactive software application 804-1 and the second interactive software application 804-2 are in communication with one another. For example, the first interactive software application 804-1 and the second interactive software application 804-2 may be in direct data communication with one another via a network 831 (e.g., peer-to-peer communication). In some examples, the first interactive software application 804-1 and the second interactive software application 804-2 may be in data communication with a multiplayer or multi-user server that facilitates communication between the first interactive software application 804-1 and the second interactive software application 804-2 and/or between the first interactive software application 804-1 and the second interactive software application 804-2 and a shared instance of a resource on the server, such as a shared virtual environment or shared document.

In some embodiments, a control plane 833 is in communication with the plurality of autonomous agents 802-1, 802-2. For example, the control plane 833 may be a client device (such as the client device 103 described in relation to FIG. 1) to which a user provides objectives or instructions that are distributed to the plurality of autonomous agents 802-1, 802-2. In some embodiments, the control plane 833 executes on the same computing device as at least one of the autonomous agents 802-1, 802-2. In some embodiments, the control plane 833 executes on the same computing device as the autonomous agents 802-1, 802-2. In some embodiments, the control plane 833 executes on a control computing device that is different from either of the agent computing devices executing the autonomous agents 802-1, 802-2. In some embodiments, the autonomous agents 802-1, 802-2 are both or each executed on the same agent computing device.

The present disclosure relates to systems and methods for creating autonomous agents for testing interactive software applications according to at least the examples provided in the clauses below:

Clause 1. A system for interacting with an interactive software application, the system comprising: an agent computing device including: a crawler engine configured to create a graph; a state detector in communication with the crawler engine and configured to provide state information to the crawler engine; and an emulator in communication with the crawler engine, wherein the emulator generates emulated inputs in response to an action selected by the crawler engine.

Clause 2. The system of clause 1, wherein the crawler engine includes a machine learning model.

Clause 3. The system of clause 1 or 2, wherein the crawler engine is in data communication with an application module associated with the interactive software application.

Clause 4. The system of clause 3, wherein the application module includes a scripted action.

Clause 5. The system of clause 3, wherein the application module includes content embeddings.

Clause 6. The system of clause 3, wherein the application module includes an interactive software application ID.

Clause 7. The system of any preceding clause, wherein the crawler engine further includes a language model, and the language model is in data communication with a client device and configured to receive instructions from the client device.

Clause 8. The system of any preceding clause, wherein the state detector includes or is in communication with a vision model.

Clause 9. The system of any preceding clause, wherein the state detector includes or is in communication with an optical character recognition (OCR) model.

Clause 10. The system of any preceding clause, wherein the state detector includes or is in communication with an audio language model.

Clause 11. A method of interacting with an interactive software application, the method comprising: instantiating an autonomous agent; obtaining at least one of a first video information and first audio information of a user interface (UI) from the interactive software application at a state detector of the autonomous agent; transmitting first state information from the state detector to a crawler engine of the autonomous agent based at least partially on the at least one of first video information and first audio information; selecting an action with the crawler engine in response to the first state information; transmitting the action to an emulator of the autonomous agent; transmitting at least one emulated input of the action to the interactive software application; obtaining at least one of a second video information and second audio information from the interactive software application at a state detector of the autonomous agent; transmitting second state information from the state detector to a crawler engine of the autonomous agent based at least partially on the at least one of second video information and second audio information; and based a difference between the first state information and the second state information, updating a graph.

Clause 12. The method of clause 11, further comprising recording the graph in an application module.

Clause 13. The method of clause 11 or 12, wherein the action is selected from an action inventory.

Clause 14. The method of any of clauses 11 through 13, wherein the action is selected based at least partially on an input legend in the first video information.

Clause 15. The method of any of clauses 11 through 14, wherein the action is selected based at least partially on an input cue in the first video information.

Clause 16. The method of any of clauses 11 through 15, further comprising selecting a scripted action to transition the interactive software application to a second section of the UI that is not navigable therebetween within the UI.

Clause 17. The method of any of clauses 11 through 16, wherein the graph includes a plurality of navigable paths, and the navigable paths include confirmation input paths and directional input paths.

Clause 18. A method of interacting with an interactive software application, the method comprising: receiving first state information of a user interface (UI) of an interactive software application at a crawler engine from a state detector; receiving an objective input with the crawler engine from a user; selecting an action with the crawler engine from an action inventory based at least partially on the state information and the objective; transmitting an input to the interactive software application based on the action; after transmitting the input, receiving second state information of the user interface of the interactive software application at the crawler engine from the state detector; comparing a change in state information between the first state information and the second state information to an expected change in state of a graph; and reporting an error, change, or limitation of the UI based on comparing the change to the expected change.

Clause 19. The method of clause 18, further comprising accessing an application module to obtain at least a portion of the action inventory.

Clause 20. The method of clause 18, wherein the expected change in state of the graph is based on a graph created from a different build or version of the interactive software application.

Clause 21. The method of clause 18, wherein the expected change is obtained based on an objective provided by a user input.

Clause 22. The method of clause 18, wherein the expected change is obtained based on visual information in the state information.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the scope of the present disclosure, and that various changes, substitutions, and alterations may be made to embodiments disclosed herein without departing from the scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

It should be understood that any directions or reference frames in the preceding description are merely relative directions or movements. For example, any references to “front” and “back” or “top” and “bottom” or “left” and “right” are merely descriptive of the relative position or movement of the related elements.

The present disclosure may be embodied in other specific forms without departing from its characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A system for interacting with a user interface of an interactive software application, the system comprising:
an agent computing device including:
a crawler engine configured to create a graph;
a state detector in communication with the crawler engine and configured to provide state information to the crawler engine; and
an emulator in communication with the crawler engine, wherein the emulator generates emulated inputs in response to an action selected by the crawler engine.

2. The system of claim 1, wherein the crawler engine includes a machine learning model.

3. The system of claim 1, wherein the crawler engine is in data communication with an application module associated with the interactive software application.

4. The system of claim 3, wherein the application module includes a scripted action.

5. The system of claim 3, wherein the application module includes content embeddings.

6. The system of claim 3, wherein the application module includes an interactive software application ID.

7. The system of claim 1, wherein the crawler engine further includes a language model, and the language model is in data communication with a client device and configured to receive instructions from the client device.

8. The system of claim 1, wherein the state detector includes or is in communication with a vision model.

9. The system of claim 1, wherein the state detector includes or is in communication with an optical character recognition (OCR) model.

10. The system of claim 1, wherein the state detector includes or is in communication with an audio language model.

11. A method of interacting with an interactive software application, the method comprising:
instantiating an autonomous agent;
obtaining at least one of a first video information and first audio information of a user interface (UI) from the interactive software application at a state detector of the autonomous agent;
transmitting first state information from the state detector to a crawler engine of the autonomous agent based at least partially on the at least one of first video information and first audio information;
selecting an action with the crawler engine in response to the first state information;
transmitting the action to an emulator of the autonomous agent;
transmitting at least one emulated input of the action to the interactive software application;
obtaining at least one of a second video information and second audio information from the interactive software application at a state detector of the autonomous agent;
transmitting second state information from the state detector to a crawler engine of the autonomous agent based at least partially on the at least one of second video information and second audio information; and
based a difference between the first state information and the second state information, updating a UI graph.

12. The method of claim 11, wherein updating the UI graph includes updating a screen node.

13. The method of claim 11, wherein updating the UI graph includes updating option node.

14. The method of claim 11, wherein the action is selected based at least partially on an input legend in the first video information.

15. The method of claim 11, wherein the action is selected based at least partially on an input cue in the first video information.

16. The method of claim 11, further comprising selecting a scripted action to transition the interactive software application to a second section of the UI that is not navigable therebetween within the UI.

17. The method of claim 11, wherein the graph includes a plurality of navigable paths, and the navigable paths include confirmation input paths and directional input paths.

18. A method of interacting with an interactive software application, the method comprising:
receiving first state information of a user interface (UI) of an interactive software application at a crawler engine from a state detector;
selecting an action with the crawler engine from an action inventory based at least partially on the state information;
transmitting an input to the interactive software application based on the action;
after transmitting the input, receiving second state information of the user interface of the interactive software application at the crawler engine from the state detector;
comparing an observed change in state information between the first state information and the second state information to an expected change in state of a UI graph; and
reporting an error, change, or limitation of the UI based on comparing the observed change to the expected change.

19. The method of claim 18, wherein the expected change is obtained based on an objective provided by a user input.

20. The method of claim 18, wherein the expected change is obtained based on visual information in the state information.
